(19) United States
(12) Patent Application Publication
(10) Pub. No.: US 2021/0214817 A1
(43) Pub. Date: Jul. 15, 2021

(54) STEEL ALLOY AND METHOD FOR HEAT TREATING A STEEL ALLOY ARTICLE

(71) Applicant: The Boeing Company, Chicago, IL (US)

(72) Inventors: Daniel E. Sievers, Owens Cross Roads, AL (US); Matthew Carter, Portland, OR (US)

(73) Assignee: The Boeing Company, Chicago, IL (US)

(21) Appl. No.: 16/743,355

(22) Filed: Jan. 15, 2020

(51) Int. Cl. C21D 9/32; C21D 6/00; C21D 1/42; C21D 1/18; C22C 38/54; C22C 38/48; C22C 38/44; C22C 38/42; C22C 38/06; C22C 38/02; C22C 38/04; C22C 38/00

(52) U.S. Cl. CPC C21D 9/32; C22C 38/001; C21D 6/005; C21D 6/008; C21D 1/42; C21D 1/18; C22C 38/54; C22C 38/48; C22C 38/44; C22C 38/42; C22C 38/06; C22C 38/02; C22C 38/04; C22C 38/002; C21D 6/004

(57) ABSTRACT

A steel alloy includes about 1.65 to about 2 percent by weight nickel (Ni), about 0.7 to about 0.9 percent by weight chromium (Cr), about 0.6 to about 0.9 percent by weight manganese (Mn), about 0.58 to about 0.63 percent by weight carbon (C), about 0.25 to about 0.35 percent by weight niobium (Nb), about 0.15 to about 0.35 percent by weight silicon (Si), about 0.2 to about 0.3 percent by weight molybdenum (Mo), about 0.005 to about 0.01 percent by weight boron (B), and iron (Fe).

### FIELD

This application relates to steel alloys and methods for heat treating steel alloy articles.

### BACKGROUND

Steel alloys have attractive mechanical properties resulting from the addition of various elements to the iron-based compositions. One commonly used steel alloy is 4340 steel, which is a heat treatable low alloy steel containing chromium, nickel and molybdenum, and which has high toughness and high strength. Therefore, 4340 steel is used in a variety of applications, including commercial and military aircraft, automotive systems and various machine tool applications.

Despite advances already made, those skilled in the art continue with research and development efforts in the field of steel alloys.

### SUMMARY

Disclosed are steel alloys, particularly steel alloys that include iron (Fe), nickel (Ni), chromium (Cr), manganese (Mn), carbon (C), niobium (Nb), silicon (Si), molybdenum (Mo), and boron (B)

In one example, the disclosed steel alloy includes about 1.65 to about 2 percent by weight nickel (Ni), about 0.7 to about 0.9 percent by weight chromium (Cr), about 0.6 to about 0.9 percent by weight manganese (Mn), about 0.58 to about 0.63 percent by weight carbon (C), about 0.25 to about 0.35 percent by weight niobium (Nb), about 0.15 to about 0.35 percent by weight silicon (Si), about 0.2 to about 0.3 percent by weight molybdenum (Mo), about 0.005 to about 0.01 percent by weight boron (B), and balance iron (Fe).

In another example, the disclosed steel alloy consists essentially of about 1.65 to about 2 percent by weight nickel (Ni), about 0.7 to about 0.9 percent by weight chromium (Cr), about 0.6 to about 0.9 percent by weight manganese (Mn), about 0.58 to about 0.63 percent by weight carbon (C), about 0.25 to about 0.35 percent by weight niobium (Nb), about 0.15 to about 0.35 percent by weight silicon (Si), about 0.2 to about 0.3 percent by weight molybdenum (Mo), about 0.005 to about 0.01 percent by weight boron (B), and balance iron (Fe).

Also disclosed are articles manufactured from the disclosed steel alloys, such as gears and various aircraft components (e.g., wing components and helicopter component).

Also disclosed are methods for heat treating steel alloy articles manufactured from the disclosed the steel alloys.

In one example, the disclosed method for heat treating steel alloy articles includes the step of induction hardening an outer surface of a steel alloy article that includes about 1.65 to about 2 percent by weight nickel (Ni), about 0.7 to about 0.9 percent by weight chromium (Cr), about 0.6 to about 0.9 percent by weight manganese (Mn), about 0.58 to about 0.63 percent by weight carbon (C), about 0.25 to about 0.35 percent by weight niobium (Nb), about 0.15 to about 0.35 percent by weight silicon (Si), about 0.2 to about 0.3 percent by weight molybdenum (Mo), about 0.005 to about 0.01 percent by weight boron (B), and iron (Fe).

Other examples of the disclosed steel alloys, articles manufactured from the disclosed steel alloys, and methods for heat treating steel alloy articles will become apparent from the following detailed description, the accompanying drawings and the appended claims.

### BRIEF DESCRIPTION OF THE DRAWINGS

FIG. 1 is a front elevational view of an induction hardened gear manufactured from the disclosed steel alloy;

FIG. 2 is a block diagram of aircraft production and service methodology.

FIG. 3 is a schematic illustration of an aircraft.

### DETAILED DESCRIPTION

Disclosed are steel alloys that may be used in an induction hardened form.

Significantly, articles formed from the disclosed steel alloys using induction hardening techniques may have mechanical and durability performance properties, such as hardness, ultimate tensile strength and fracture toughness, that are at least as good as (if not better than) the mechanical and durability properties of articles formed from conventional 4340 steel. Therefore, the disclosed steel alloys offer an alternative to 4340 alloy steel that is particularly suitable for use in demanding applications.

In a first example, the disclosed steel alloy has the composition shown in Table 1.

TABLE 1

| Element | Range (wt %) |
|---|---|
| Nickel | 1.65-2.0 |
| Chromium | 0.7-0.9 |
| Manganese | 0.6-0.9 |
| Carbon | 0.58-0.63 |
| Niobium | 0.25-0.35 |
| Silicon | 0.15-0.35 |
| Molybdenum | 0.2-0.3 |
| Boron | 0.005-0.01 |
| Iron | Balance |

Therefore, in an example, the disclosed steel alloy may consist essentially of nickel (Ni), chromium (Cr), manganese (Mn), carbon (C), niobium (Nb), silicon (Si), molybdenum (Mo), boron (B), and iron (Fe).

The concentration of nickel (Ni) of the steel alloy of the first example may be range from about 1.65 to about 2 percent by weight nickel, such as from about 1.7 to about 1.9 percent by weight.

The concentration of chromium (Cr) of the steel alloy of the first example may be range from about 0.7 percent by weight to about 0.9 percent by weight, such as from about 0.75 to about 0.85 percent by weight.

The concentration of manganese (Mn) of the steel alloy of the first example may be range from about 0.6 percent by weight to about 0.9 percent by weight, such as from about 0.65 to about 0.85 percent by weight.

The concentration of carbon (C) of the steel alloy of the first example may be range from about 0.58 percent by weight to about 0.63 percent by weight, such as from about 0.58 percent by weight to about 0.62 percent by weight, from about 0.58 percent by weight to about 0.61 percent by weight, from about 0.59 percent by weight to about 0.63 percent by weight, or from about 0.6 percent by weight to about 0.63 percent by weight.

The concentration of niobium (Nb) of the steel alloy of the first example may be range from about 0.25 percent by weight to about 0.35 percent by weight, such as from about 0.25 percent by weight to about 0.33 percent by weight, from about 0.25 percent by weight to about 0.3 percent by weight, from about 0.28 percent by weight to about 0.35 percent by weight, or from about 0.3 percent by weight to about 0.35 percent by weight.

The concentration of silicon (Si) of the steel alloy of the first example may be range from about 0.15 percent by weight to about 0.35 percent by weight, such as from about 0.17 percent by weight to about 0.33 percent by weight.

The concentration of molybdenum (Mo) of the steel alloy of the first example may be range from about 0.2 percent by weight to about 0.3 percent by weight, such as from about 0.21 percent by weight to about 0.29 percent by weight.

The concentration of boron (B) of the steel alloy of the first example may be range of from about 0.005 percent by weight to about 0.01 percent by weight, such as from about 0.005 percent by weight to about 0.008 percent by weight, such as from about 0.005 percent by weight to about 0.007 percent by weight, such as from about 0.006 percent by weight to about 0.009 percent by weight, such as from about 0.007 percent by weight to about 0.01 percent by weight, such as from about 0.0075 percent by weight to about 0.0049 percent by weight.

Those skilled in the art will appreciate that various impurities, which do not substantially affect the physical properties of the steel alloy of the first example, may also be present, and the presence of such impurities will not result in a departure from the scope of the present disclosure. For example, the impurities content of the steel alloy of the first example may be controlled as shown in Table 2.

TABLE 2

| Impurity | Maximum (wt %) |
|---|---|
| Oxygen | 0.01 |
| Copper | 1.0 |
| Sulfur | 0.15 |
| Phosphorous | 0.035 |
| Aluminum | 0.05 |
| Nitrogen | 0.025 |

One specific, non-limiting example of a steel alloy of the first example has the composition shown in Table 3. The impurities content of the steel alloy melt of the first example may be controlled as shown in Table 2.

TABLE 3

| Element | Target (wt %) | Actual (wt %) |
|---|---|---|
| Nickel | 1.8 | 1.81 |
| Chromium | 0.8 | 0.79 |
| Manganese | 0.75 | 0.75 |
| Carbon | 0.6 | 0.6 |
| Niobium | 0.3 | 0.28 |
| Silicon | 0.25 | 0.26 |
| Molybdenum | 0.25 | 0.24 |
| Boron | 0.0075 | 0.0049 |
| Oxygen | 0.0035 | 0.0014 |
| Copper | 0.014 | 0.15 |
| Sulfur | 0.01 | 0.009 |
| Phosphorous | 0.008 | 0.010 |
| Aluminum | 0.015 | 0.023 |
| Nitrogen | 0.009 | 0.0082 |
| Iron | Balance | Balance |

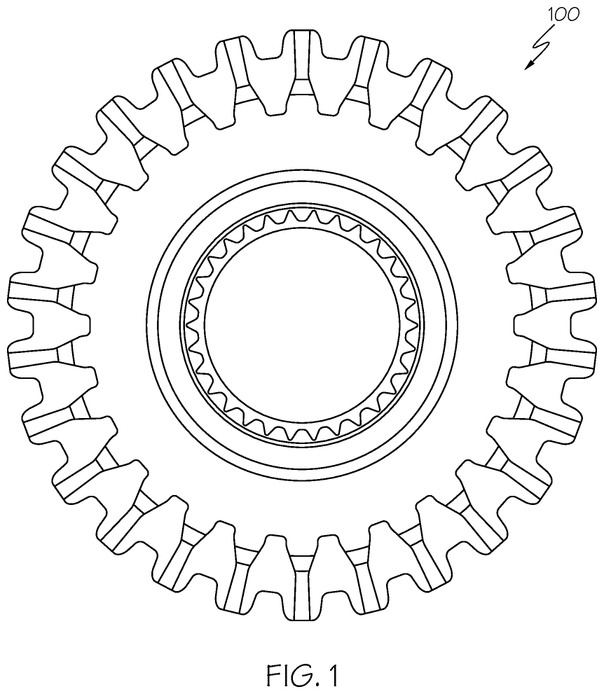

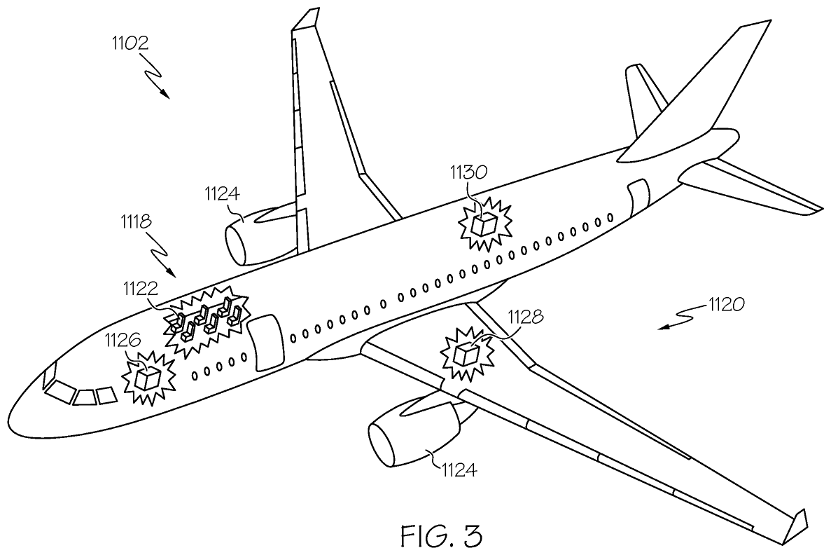

The disclosed steel alloy may be used to manufacture various articles, such as aerospace articles or components, including aircraft articles or components. As one example, a gear, such as the gear 100 shown in FIG. 1, may be manufactured from the disclosed steel alloy. Other articles, such as aircraft components (e.g., a wing component and/or a helicopter component) (see aircraft 1102 in FIG. 3), may also be manufactured from the disclosed steel alloy. Such articles may be manufactured by casting the disclosed steel alloy or forging the disclosed steel alloy, though the use of other manufacturing techniques (e.g., additive manufacturing) is also contemplated and the use of other manufacturing techniques will not result in a departure from the scope of the present disclosure. As noted herein, the induction hardened form of the disclosed steel alloy is attractive (particularly vis-a-vis 4340 steel) due to improvement in mechanical properties, particularly hardness, ultimate tensile strength and fracture toughness.

Also disclosed is a heat-treating method, by way of induction heating, for manufacturing articles using the disclosed steel alloy composition. One example of the disclosed method for manufacturing an article may begin with the step of preparing a steel alloy composition. The steel alloy composition prepared may have a composition falling within the compositional limits recited in Table 1. The steel alloy then may then be subjected to induction heating to achieve the desired physical properties.

In one specific, non-limiting example, the method of induction heating may include heating the steel alloy article, falling within the compositional limits in Table 1, to a temperature at least about 830° C., and maintaining at temperature for at least about 0.1 seconds. In another specific, non-limiting example, the method of induction heating may include heating the steel alloy article, falling within the compositional limits in Table 1, to a temperature at least about 1100° C., and maintaining at temperature for at least about 0.1 seconds. The heat-treated alloy may then be quenched.

Additionally, the induction heated alloy may be tempered. For example, the induction heated alloy may be tempered at a temperature ranging from about 150° C. to about 200° C.

Induction hardened articles manufactured from the disclosed steel alloys may exhibit excellent mechanical properties, particularly hardness, ultimate tensile strength and fracture toughness. Induction hardened articles manufactured from the disclosed steel alloys may have a hardness of at least about 59 HRC, such as a hardness of at least about 60 HRC or a hardness of at least about 61 HRC or a hardness of at least about 62 HRC. Induction hardened articles manufactured from the disclosed steel alloys may have a fracture toughness, in accordance with ASTM E399, of at least about 40 MPa*√m, such as a fracture toughness of at least about 45 MPa*√m or a fracture toughness of at least about 50 MPa*√m or a fracture toughness of at least about 55 MPa*√m. Induction hardened articles manufactured from the disclosed steel alloys may have an ultimate tensile strength of at least about 1100 MPa, such as an ultimate tensile strength of at least about 1200 MPa or an ultimate tensile strength of at least about 1300 MPa or an ultimate tensile strength of at least about 1400 MPa or an ultimate tensile strength of at least about 1500 MPa or an ultimate tensile strength of at least about 1600 MPa or an ultimate tensile strength of at least about 1700 MPa or an ultimate tensile strength of at least about 1800 MPa or an ultimate tensile strength of at least about 1900 MPa or an ultimate tensile strength of at least about 2000 MPa or an ultimate tensile strength of at least about 2100 MPa or an ultimate tensile strength of at least about 2200 MPa.

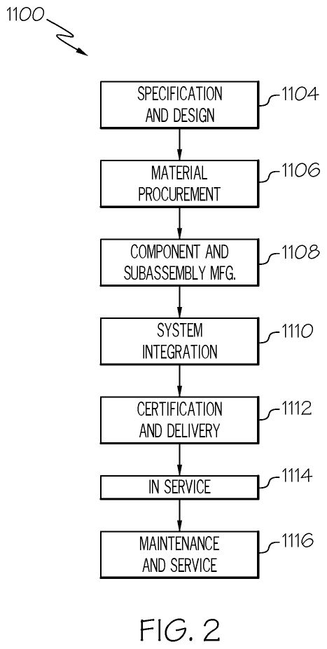

Examples of the present disclosure may be described in the context of aircraft manufacturing and service method 1100 as shown in FIG. 2 and aircraft 1102 as shown in FIG. 3. During pre-production, illustrative method 1100 may include specification and design (block 1104) of aircraft 1102 and material procurement (Block 1106). During production, component and subassembly manufacturing (Block 1108) and system integration (Block 1110) of aircraft 1102 may take place. Thereafter, aircraft 1102 may go through certification and delivery (Block 1112) to be placed in service (Block 1114). While in service, aircraft 1102 may be scheduled for routine maintenance and service (Block 1116). Routine maintenance and service may include modification, reconfiguration, refurbishment, etc. of one or more systems of aircraft 1102.

Each of the processes of illustrative method 1100 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization and so on.

As shown in FIG. 3, aircraft 1102 produced by illustrative method 1100 may include airframe 1118 with a plurality of high-level systems 1120 and interior 1122. Examples of high-level systems 1120 include one or more of propulsion system 1124, electrical system 1126, hydraulic system 1128, and environmental system 1130. Any number of other systems may be included. Although an aerospace example is shown, the principles disclosed herein may be applied to other industries, such as the automotive industry. Accordingly, in addition to aircraft 1102, the principles disclosed herein may apply to other vehicles, e.g., land vehicles, marines, marine vehicles, space vehicles, etc.

Apparatus(es) and method(s) shown or described herein may be employed during any one or more of the stages of the manufacturing and service method 1100. For example, components or subassemblies corresponding to component and subassembly manufacturing (block 1108) may be fabricated or manufactured in a manner similar to components or subassemblies produced while aircraft 1102 is in service (Block 1114). Also, one or more examples of the apparatus(es), method(s), or combination thereof may be utilized during production stages (Blocks 1108 and 1110), for example, by substantially expediting assembly of or reducing the cost of aircraft 1102. Similarly, one or more examples of the apparatus or method realizations, or a combination thereof, may be utilized, for example and without limitation, while aircraft 1102 is in service (Block 1114) and/or during maintenance and service (Block 1116).

Different examples of the apparatus(es) and method(s) disclosed herein include a variety of components, features, and functionalities. It should be understood that the various examples of the apparatus(es) and method(s) disclosed herein may include any of the components, features, and functionalities of any of the other examples of the apparatus(es) and method(s) disclosed herein in any combination, and all of such possibilities are intended to be within the scope of the present disclosure.

Although various examples of the disclosed steel alloy and method for heat treating a steel alloy article have been shown and described, modifications may occur to those skilled in the art upon reading the specification. The present application includes such modifications and is limited only by the scope of the claims.

1. A steel alloy comprising:
about 1.65 to about 2 percent by weight nickel;
about 0.7 to about 0.9 percent by weight chromium;
about 0.6 to about 0.9 percent by weight manganese;
about 0.58 to about 0.63 percent by weight carbon;
about 0.25 to about 0.35 percent by weight niobium;
about 0.15 to about 0.35 percent by weight silicon;
about 0.2 to about 0.3 percent by weight molybdenum;
about 0.005 to about 0.01 percent by weight boron; and
iron.

2. (canceled)

3. The steel alloy of claim 1 wherein the niobium is present at about 0.25 to about 0.3 percent by weight.

4. (canceled)

5. The steel alloy of claim 1 wherein the niobium is present at about 0.3 to about 0.35 percent by weight.

6-7. (canceled)

8. The steel alloy of claim 1 wherein the boron is present at about 0.006 to about 0.009 percent by weight.

9. (canceled)

10. The steel alloy of claim 1 wherein the carbon is present at about 0.58 to about 0.62 percent by weight.

11-13. (canceled)

14. The steel alloy of claim 1 wherein the nickel is present at about 1.7 to about 1.9 percent by weight.

15. The steel alloy of claim 1 wherein the chromium is present at about 0.75 to about 0.85 percent by weight.

16. The steel alloy of claim 1 wherein the manganese is present at about 0.65 to about 0.85 percent by weight.

17. The steel alloy of claim 1 wherein the silicon is present at about 0.17 to about 0.33 percent by weight.

18. The steel alloy of claim 1 wherein the molybdenum is present at about 0.21 to about 0.29 percent by weight.

19. The steel alloy of claim 1 consisting essentially of:
the nickel, the chromium, the manganese, the carbon, the niobium, the silicon, the molybdenum, and the boron;
optionally, at least one of oxygen, copper, sulfur, phosphorous, aluminum, and nitrogen; and
balance the iron and incidental impurities.

20-25. (canceled)

26. An aerospace article formed from the steel alloy of claim 1.

27. An aircraft component comprising the steel alloy of claim 1.

28-30. (canceled)

31. A method for heat treating a steel alloy article comprising the steel alloy of claim 1, the method comprising:
induction hardening an outer surface of the steel alloy article.

32. The method of claim 31 wherein the induction hardening comprises heating the steel alloy article to a temperature at least about 830° C.

33. The method of claim 32 wherein the induction hardening comprises holding the steel alloy article at the temperature for at least about 0.1 seconds.

34. The method of claim 31 further comprising quenching the steel alloy article.

35. The method of claim 31 further comprising tempering the steel alloy article at a temperature ranging from about 150° C. to about 200° C.

36. An induction hardened steel alloy article manufactured by the method of claim 31.

37. The induction hardened steel alloy article of claim 36 comprising a hardness of at least about 59 HRC.

38. The induction hardened steel alloy article of claim 36 comprising a hardness of at least about 60 HRC.

39-40. (canceled)

41. The induction hardened steel alloy article of claim 36 comprising an ultimate tensile strength of at least about 1100 MPa.

42. The induction hardened steel alloy article of claim 36 comprising a fracture toughness of at least about 40 MPa*√m.
